(19) United States
(12) Patent Application Publication
(10) Pub. No.: US 2025/0005230 A1
(43) Pub. Date: Jan. 2, 2025

(54) METHOD FOR TESTING AN ELECTRONIC CONTROL UNIT WITH A SIMULATOR

(71) Applicant: dSPACE GmbH, Paderborn (DE)

(72) Inventors: Axel KIFFE, Paderborn (DE); Thorben HOFFSTADT, Paderborn (DE)

(73) Assignee: dSPACE GmbH, Paderborn (DE)

(21) Appl. No.: 18/760,736

(22) Filed: Jul. 1, 2024

(30) Foreign Application Priority Data
Jun. 29, 2023 (DE) 10 2023 117 151.8

(51) Int. Cl. G06F 30/20; G06F 111/10

(52) U.S. Cl. CPC G06F 30/20; G06F 2111/10

(57) ABSTRACT

A computer-implemented method for testing an ECU with a simulator is described and presented. The simulator numerically computes a mathematical environment model on a computational unit. The environment model simulates the environment of the ECU at least in part. The ECU and the simulator are coupled with each other via appropriate I/O interfaces and interact with each other. A matrix-vector multiplication is performed when the environment model is numerically computed on the simulator, in which a matrix is multiplied by a vector to form a result vector. The matrix-vector multiplication is broken down into a sequence of summations by two summands, wherein each summand is a product of two factors, one factor being an element of the matrix and the other factor being an element of the vector.

This nonprovisional application claims priority under 35 U.S.C. § 119 (a) to German Patent Application No. 10 2023 117 151.8, which was filed in Germany on Jun. 29, 2023, and which is herein incorporated by reference.

### BACKGROUND OF THE INVENTION

### Field of the Invention

The invention relates to a computer-implemented method for testing an ECU with a simulator, wherein the simulator numerically computes a mathematical environment model on a computational unit, wherein the environment model simulates the environment of the ECU at least in part, wherein the ECU and the simulator are coupled with each other via corresponding I/O interfaces and interact with each other, wherein during the numerical computation of the environment model, a matrix-vector multiplication is performed on the simulator in which a matrix is multiplied by a vector to form a result vector, wherein the matrix-vector multiplication is broken down into a sequence of summations by two summands, wherein each summand is a product of two factors, one factor being an element of the matrix and the other factor being an element of the vector.

### Description of the Background Art

The computer-implemented methods mentioned here come from the field of hardware-in-the-loop simulation (HIL simulation), in which the environment of an ECU is simulated, partially or completely. This makes it possible to try out and test the ECU safely in a simulated environment and not in the real physical process in which it will later be used. A typical example is an ECU for an electric drive, for example from the automotive sector, whose environment, i.e., the electric drive and, if necessary, other environmental components (e.g., chassis of the vehicle), are simulated with the simulator. For this purpose, the ECU is connected to a corresponding I/O interface of the simulator via its I/O interface, so that corresponding signals (power signals from semiconductor bridges, sensor signals, etc.) can be exchanged as in real use of the ECU. In the case of the electric drive mentioned as an example, the simulator then also includes suitable power electronics modules to simulate corresponding electrical loads for the ECU.

The ECU can be available in different forms, as a development ECU, which is still different from the final hardware realization, as a final series ECU, but also as a virtual ECU, i.e., as a software replica. In the latter case, too, the simulator and the ECU are connected via corresponding I/O interfaces, even if these are only implemented in terms of data technology.

The test of the ECU includes the ECU being operated together with the simulator, as this makes it possible to determine whether the ECU and the controller implemented on it realize the expected behavior, i.e., a comparison is made between an expected target behavior and the actual behavior experienced in the simulation. For this purpose, it is not only necessary for the mathematical environment model to be computed numerically as accurately as possible, but it must also be computed in real time for real-time simulations: The computation of the system behavior in a time interval of one second of simulation time must therefore be completed in one second of physical real-time, at the latest. In particular, the simulation of power electronic systems with fast-switching semiconductors is extremely challenging, because the systems often have large eigenvalues and thus have high rates of change over time in the state variables, especially in comparison to mechanical systems. Great efforts are made to improve the numerical handling of the simulations to meet the real-time requirements for simulation and/or special hardware is used to make fast computations possible, such as the use of programmable logic devices, often in the form of FPGAs (Field Programmable Gate Arrays).

The numerical computation of differential equation systems almost always involves matrix operations, often in the form of matrix-vector multiplications, which is immediately obvious when, for example, the state space description of a system is considered after time discretization-which goes hand in hand with numerical methods (see, for example, WO 2020/099659 A1, which corresponds to US 2021/0264084, which is incorporated herein by reference).

Especially when using FPGAs, it is usually necessary to work with elemental adders, with which only two summands can be added to a sum. In matrix-vector multiplication, sums with a large number of summands often occur, i.e., at most equal to the number of row elements in a row in the matrix involved. Consequently, the sum must be broken down into subtotals, i.e., into the aforementioned sequence of summations by two summands. The object of the present invention is to further improve such a matrix-vector multiplication.

### SUMMARY OF THE INVENTION

It is therefore an object of the present invention to provide a method for testing an ECU with a simulator, by determining in a sequence determination step, a summation as a next summation in a sequence whose summands depend on matrix elements from a highest populated row in the matrix, wherein the matrix elements are selected from the highest populated row that have the highest total usability.

It is preferred to use matrix elements from a row that is as highly populated as possible with high priority, because in a highly populated row, at most, additions of two can be performed until the final sum of the row is computed. Furthermore, it is preferred to start with those elements from this row that have the highest possible total usability, i.e., with which, on the one hand, pairs of summands can be formed in principle and, on the other hand, pairs of summands can be formed, which also reappear in another row in the matrix. Both contribute to the total usability of a matrix element. The total usability is therefore also a measure of the reusability of a pair of summands when calculating the matrix vector product.

Furthermore, the sequence determination step can be repeated with a residual matrix instead of the matrix until the residual matrix no longer has any non-zero matrix elements, wherein the residual matrix is derived from the matrix by setting all matrix elements in the matrix to zero that are involved in a summation already scheduled in the sequence. The residual matrix therefore contains all matrix elements of the matrix which have not been scheduled yet for a summation.

The summations can be performed in the scheduled sequence, wherein the product formations for calculating the summands are performed in the sequence in which the summands are required to perform the summation. The product formations between a matrix element of the matrix and a vector element of the vector follow the scheduling of the summations, i.e., the products are computed when they are required for a summation.

In a final summation step, the sums resulting from the preceding summation in each row of the result vector are computed by consecutive pairwise addition.

The matrix can be examined for matrix elements of equal amount in a column of the matrix, since products of equal amount are to be computed at these matrix positions with the same matrix elements in a column. A corresponding product of the amount of one of the matrix elements of the same amount and the amount of a corresponding vector element of the vector is computed only once. The computation result for the product at the other matrix positions with matrix elements that are identical in amount is then only retrieved and not recomputed. This specifically reduces the computation effort required to compute the matrix-vector product. Preferably, if the matrix element and the corresponding vector element have different signs, only one sign bit of the precomputed product in terms of amount is set, which also reduces the computation effort.

In order to further reduce the computation effort, it is provided that the matrix can be examined for multiple identical matrix elements in two different rows and in identical columns of the matrix, since this corresponds to identical sums or subtotals in the result vector, wherein such a sum or subtotal is computed only once, and the computation result in the other rows having identical sums or subtotals for calculating the result vector is only retrieved and not recomputed. Since such matrix positions are given preference in the sequence determination step when forming sums that have high total usability, identical multiple computations are detected right at the beginning of the method and the residual matrix is thus quickly thinned out. It is also ensured that the sums are identical in terms of amount, as also in this case the sum only has to be computed once. A sign change can be easily realized by setting the sign bit accordingly.

The significance of the usability of sums has been explained above in general terms. There are various ways to implement the numerical computation of the measure of total usability in concrete terms. In an example of the method, it has been proven that the total usability of an element of the matrix is valued as 1 in the case of a non-zero element amount if another element of the matrix in the same row in the matrix has a non-zero element and thus the element is basically involved in forming a sum in its row. The total usability increases by the value 1 with each conceivable pair of summands in the row in the matrix that occurs with an identical amount in another row in the matrix.

If there are multiple rows in the matrix that are equally populated at the highest level, a summarized total usability is determined in a further development of the method for each of these rows of the matrix in the sequence determination step, corresponding to the sum of the total usability of the matrix elements of the corresponding row, and the row with the highest summarized total usability is then selected.

If there are multiple rows in the matrix that are equally populated at the highest level and have the same summarized total usability, one of the following variants is implemented in examples: One of the multiple rows is selected by chance or by choosing the row with the smallest row number or by choosing the row with the largest row number.

As has already been explained, in matrix-vector multiplication, sums with considerably more than two summands must be computed to compute an element of the result vector depending on the size of the matrix and the size of the vector. If the matrix has n columns, there are a maximum of n summands. Then the steps explained above must be repeated until all summations have been represented in each row by elementary additions of only two summands.

For the above-mentioned reason, a further development of the method is characterized in that in the final summation step, an auxiliary matrix can be formed having a number of rows corresponding to the number of rows of the matrix and having a number of columns corresponding to the number of summations in the already determined sequence of summation formations, in that a summation of the already determined sequence of summation formations is entered in each column, namely in the row to which the summation contributes in the result vector, in that the sequence determination step is performed with the auxiliary matrix, and that the sequence determination step is repeated with an auxiliary residual matrix instead of the auxiliary matrix until the auxiliary residual matrix no longer has any non-zero matrix elements. The auxiliary residual matrix is derived from the auxiliary matrix by setting all matrix elements in the auxiliary matrix to zero that are involved in a summation that has already been scheduled in the sequence. The summations are then performed in the now extended scheduled sequence. The sums resulting from the preceding extended summation are computed in each row of the result vector by consecutive pairwise addition.

Preferably, the described method step can be repeated until the required number of summations for the matrix-vector multiplication has been completely broken down into a sequence of summations by two summands.

If the computational unit of the simulator is a programmable logic module, then it is provided in a further development of the method that the specific sequence for the summations can be used as the basis for the computation of the matrix-vector multiplication within the framework of the environment model and that the environment model is transferred into a hardware description for the programmable logic module, wherein the programmable logic module is configured as the computational unit of the simulator with the hardware description.

By means of the presented method, matrix-vector multiplications can be performed in such an optimized manner that the speed of the computation of the environment model is significantly increased. This makes it possible to operate environment models on the simulator—especially in real time—that could not have been operated on the simulator before, in particular not in real time. By using the method, the hardware resources are optimally used, especially when programmable logic modules are used as the computational unit of the simulator.

The object described above is also achieved with a computer program containing commands that, when executed with the simulator or with a simulation environment, cause the simulator or simulation environment to perform the method described above.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 schematically shows a computer-implemented method for testing an ECU with a simulator;

FIG. 2 schematically shows, the method for testing an ECU via an example using a sequence determination step with the criteria of the highest row population and the highest total usability, as well as the application of a residual matrix;

FIG. 3 shows the example of the method according to FIG. 2 using a residual matrix;

FIG. 4 shows the example the method according to FIGS. 2 and 3 using an auxiliary matrix and an auxiliary residual matrix; and

FIG. 5 shows the computation of the matrix-vector product on the basis of the sequence of summations determined in FIGS. 2 to 4.

### DETAILED DESCRIPTION

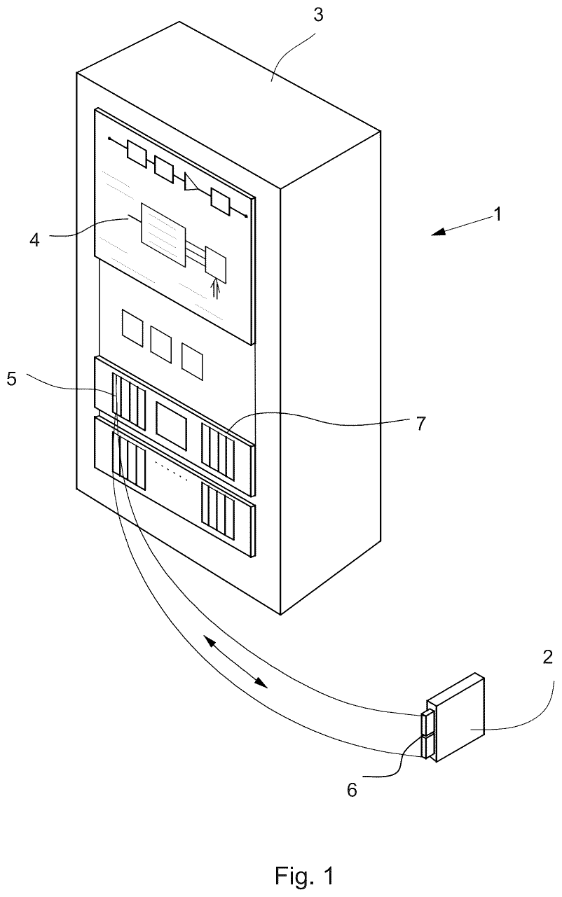

FIGS. 1 to 5 show a computer-implemented method 1 for testing an ECU 2 with a simulator 3 in various aspects.

FIG. 1 shows a typical device setup for testing the ECU 2 in the context of a so-called hardware-in-the-loop simulation. In the present case, the ECU 2 is a real development. The simulator 3 has multiple computational units, some of which are realized as Field Programmable Gate Arrays (FPGA). On one of the FPGA computational units, a mathematical environment model 4 is numerically computed, wherein the environment model 4 simulates the environment of the ECU 2. In this specific case, the ECU 2 is the ECU 2 for a three-phase electric drive, it has a corresponding power supply so that it can drive the required power. The ECU 2 also includes power electronic half-bridge assemblies with quickly switchable semiconductor switches. The simulator 3 has corresponding power electronic load modules with which the ECU 2 can be electrically loaded, wherein in regenerative operation the simulated loads can also feed energy into the ECU 2. The ECU 2 and the simulator 3 are physically coupled to each other via corresponding I/O interfaces 5, 6 and can interact with each other via them. The simulator 3 can be adapted to the hardware requirements of the environment model 4 and to the desired test cases via slide-in modules 7.

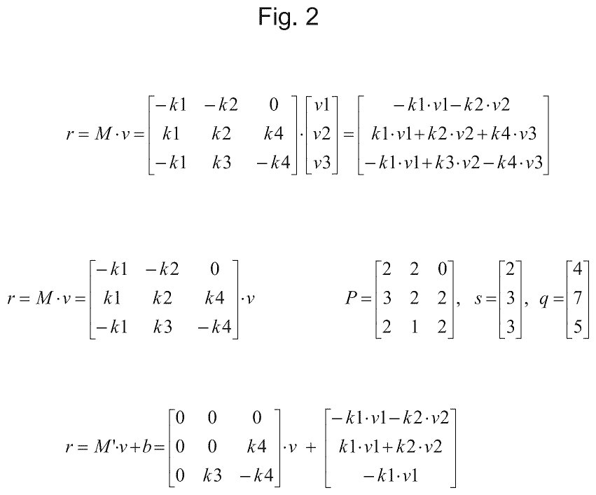

By applying numerical solution methods, matrix-vector multiplications must be performed in the numerical computation of the environment model 4 on the simulator 3. In a matrix-vector multiplication, a matrix M is multiplied by a vector v to form a result vector r. In the top row of FIG. 2, such a matrix-vector multiplication is shown using a concrete example. It is assumed that the matrix elements ki are non-zero, just like the vector elements vi. The term on the top right in the row of FIG. 2 makes it clear that sums with a large number of summands occur in matrix-vector multiplication; it reflects the mathematically correct implementation of matrix-vector multiplication without taking into account the peculiarities of the hardware architecture or the software implementation possibilities.

The use of FPGAs as computational units of the simulator 3 requires that matrix-vector multiplication must be broken down into a sequence of summations by two summands, wherein each summand is a product of two factors, one factor being an element ki of the matrix M and the other factor being an element vj of the vector v.

On the basis of the example shown in FIGS. 2 to 5, the method 1 is explained, with which matrix-vector multiplication can be performed in a time-optimized manner, so that, for example, extensive environment models 4 can be computed on the simulator 3—especially under real-time conditions—which would not have been feasible before without the application of the method 1—assuming one and the same hardware equipment.

The method 1 described below is based on the fact that the same products and equal sums from two identical summands are recognized in the entire matrix M, that the frequency of matrix elements in the participation in recurring summands is recognized and prioritized, and thus multiple computations are avoided.

In FIG. 2, it can first be seen in the middle row that in a sequence determination step 8, the summation is determined as the next summation in the sequence whose summands depend on matrix elements ki from a row in the matrix M with the highest population, wherein the matrix elements ki are chosen from the row with the highest population, which has the highest total usability P.

The population of a row in the matrix M is reflected in the vector s. The specified values simply provide information on how many positions in a row in the matrix M are populated with a non-zero value. Accordingly, there is also a corresponding number of possible summations (one less sum than non-zero positions).

Somewhat more in need of explanation is the concept of total usability P. In the middle row of FIG. 2, the matrix P is specified, which indicates the total usability of each corresponding element of the matrix M. For an element ki of the matrix M at a position Mij of the matrix M to have the highest possible total usability means, on the one hand, that in the row Mi of the element Mij there are other elements Mij of the matrix M that are non-zero, i.e., with which pair of summands can generally be formed, and on the other hand, with which pair of summands that also recur in another row in the matrix M can be formed. Both contribute to the total usability Pij of a matrix element Mij. The total usability Pij is therefore also a measure of the reusability of a matrix element Mij as a component of a pair of summands when calculating the matrix-vector product.

There are many ways to implement this valuation measure numerically. A particularly simple possibility that has been used here is that the total usability Pij of an element Mij of the matrix M is valued at 1 in the case of a nonzero element amount, if in the same row Mij of the matrix M another element Mij of the matrix M has a nonzero element amount and thus the element Mij is basically involved in a summation in its row. Furthermore, the total usability Pij increases by the value 1 with each conceivable pair of summands in the row Mi of the matrix M, which occurs identically in terms of amount in another row in the matrix M.

For example, if the total usability P11 of the matrix element M11 is assessed according to this scheme, then it must first be established that in the row M1 of the matrix M two elements are non-zero, which contributes a value of 1 to the total usability P11 of the matrix element M11. Furthermore, it must be noted that the pair of summands in the row M1 of the matrix M, formed of the matrix elements M11, M12 (with the values −k1, −k2), is identical in the row 2 in the columns 1 and 2 of the matrix M, apart from the inverse signs of the matrix elements M21, M22. This also leads to an increase in the total usability P11 of the matrix element M11 by the value 1. The total usability P11 of the matrix element M11 thus has the value 2.

As an example, the total usability P21 of the matrix element M21 is also determined. In the second row in the matrix M, in which the matrix element P21 is also located, there are also two other matrix elements that are non-zero, namely with the values k2, k4. This results in a contribution of 1 to the total usability P21 of the matrix element M21. In addition, a sum can be formed with the matrix element M23 (with the value k4). This sum has an inverted sign equivalent in row M3 of the matrix M. In addition, there is a sum of the matrix elements M21 and M22, which has a correspondence in the first row M1, namely with the matrix elements −k1, −k2. These two corresponding pairs of summands each contribute a value of 1 to the total usability P21 of the matrix element M21. The total usability P21 of the matrix element M21 is therefore 3. Following this principle, the other total usability Pij of the other matrix elements Mij can be traced in the matrix M of FIG. 2.

In the example according to FIG. 2, the rows M2, M3 of the matrix M are equally populated, i.e., with 3 elements each (see the degree of population s in rows two and three). In this case, it is questionable from which row Mi of the matrix M the matrix elements Mij from the matrix M should be used for the summation. In the example shown, in the sequence determination step 8, if there are multiple equally highly populated rows Mi of the matrix M, a summarized total usability qi is determined for each of these rows Mi of the matrix M, see the vector q, corresponding to the sum of the total usability Pi of the matrix elements Mi of the corresponding row Mi. The row Mi with the highest summarized total usability qi is then selected. In the case shown, the row 2 has the highest summarized total usability of 7 (i.e., the sum of all total usability in row two (3+2+2=7). As a result, the sum is computed with the matrix positions M21 and M22 involved.

At the same time, two further measures are taken: Attention is paid to whether identical products or sums occur again in the matrix or in the computation of the matrix-vector product in this computation of products and sums. These products or totals are marked and then retrieved and used in the appropriate position, but not recomputed.

In detail, this means that in method 1, the matrix M is examined for identical matrix elements ki in a column Mj of the matrix M, since products with identical amounts are to be computed at these matrix positions with identical matrix elements ki in a column Mj, in that a corresponding product of the amount of one of the matrix elements ki with the same amount and the amount of a corresponding vector element vj of the vector v is computed only once and the computation result for the product at the other matrix positions with matrix elements with identical amounts is only retrieved and not recomputed, in particular with a sign bit of the precomputed product in terms of amount being set accordingly if the matrix element ki and the corresponding vector element vj have different signs. This applies, for example, to the position M31 with the value −k1. The product k1*v1 can be used a total of three times, including at positions M11 and M21, there in connection with identical sums.

With regard to sums, the principle described above in the method 1 means that the matrix M is examined for multiple identical matrix elements Mij in two different rows Mi and in identical columns Mj of the matrix M, since this corresponds to identical sums or subtotals in the result vector r, wherein such a sum or subtotal is computed only once, and for calculating the result vector r, the computation result in the other rows with identical sums or subtotals is only retrieved and not recomputed. In the rows one and two of the matrix M, there are identical sums—in terms of amount—namely k1*v1+k2*v2. This sum is only computed once and only called up the second time. Here, too, if the sign is completely negated, only the sign bit of the result value is inverted.

The use of the principles of “prioritization of terms with high total usability” and “multiple use of identical products and sums” leads to a first sequence of summations with two summands. The required product formations are based on the summations. The summations k1*v1+k2*v2 and −(k1*v1+k2*v2) presuppose the computation of the products k1*v1 and k2*v2.

In row three of FIG. 2 it can be seen that the matrix M becomes an adjusted residual matrix M′. The sequence determination step 8 is repeated with a residual matrix M′ instead of the matrix M until the residual matrix M′ no longer has any non-zero matrix elements, wherein the residual matrix M′ is derived from the matrix M by setting all matrix elements Mij in the matrix M to zero that are involved in a summation b already scheduled in the sequence. The already scheduled summations and multiple product formations are thus noted in vector b, only the positions of the matrix M that have not yet been computed remain in the residual matrix M′.

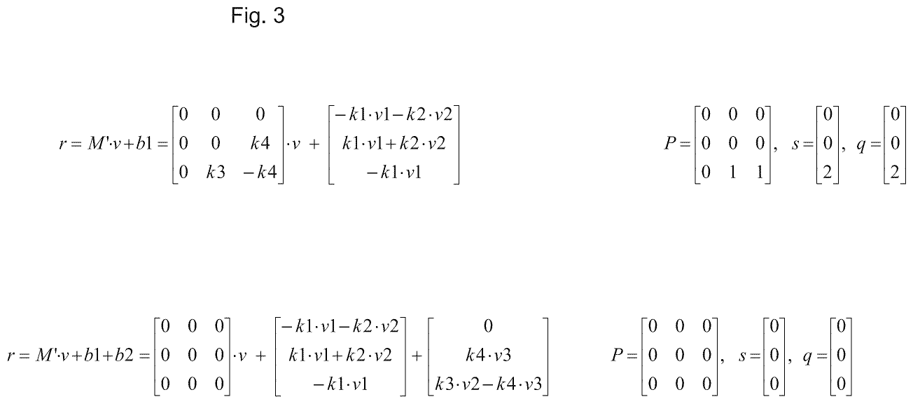

FIG. 3 shows this procedure. In the upper row, the total usability is determined for the residual matrix M′ or for each element M′ij of the residual matrix M′, which is identical with the residual matrix M′ in the third row in FIG. 2, see Matrix P, first row in FIG. 3. The elements of the summation are M32 and M33 with the values k3 and −k4, wherein the product k4*v3 can also be used at the position M23 and is marked accordingly and only retrieved but not computed. The result of this first sequence determination step 8 is the breaking down of the summation into the summations b1 and b2.

In the method 1, the summations b1, 2 are performed in the scheduled sequence, wherein the product formations for the computation of the summands are performed in the sequence in which the summands are required to perform the summation, i.e., the product computation follows the sum computation. In a final summation step 9, the sums resulting from the preceding summation in each row of the result vector r are computed by consecutive pairwise addition.

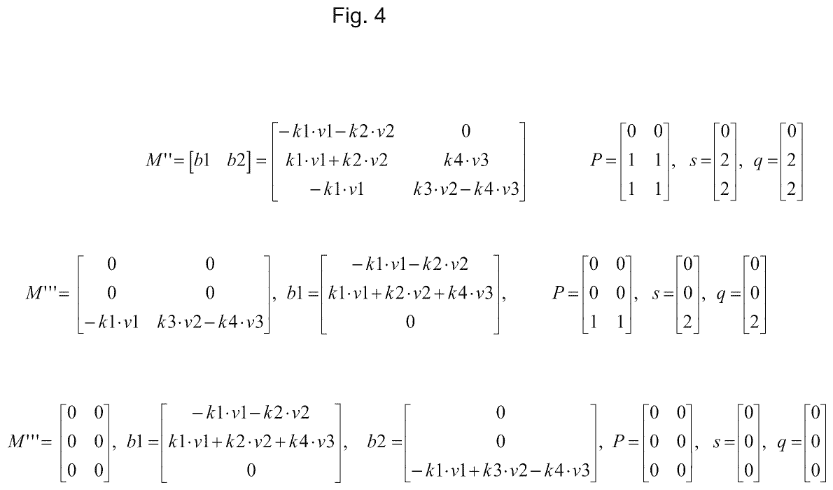

In the example, the question arises as to how to deal with the remaining summations, because so far only the summations b1 and b2 are available, but these still have to be added up for the result vector r. If the formation of elementary additions with only two summands is completely mandatory, then the additions associated with these summands will also be optimally scheduled. This is shown in FIG. 4.

In the final summation step 9, an auxiliary matrix M″ is formed with a number of rows corresponding to the number of rows of the matrix M and with a number of columns corresponding to the number of summations in the already determined sequence of summations bi, i.e., b1, b2 from FIG. 3. In each column, a summation of the already determined sequence of summations is entered, namely in the row to which the summation contributes in the result vector r. With the auxiliary matrix M″, the sequence determination step 8 is performed and the sequence determination step 8 is repeated with an auxiliary residual matrix M″ instead of the auxiliary matrix M′″ until the auxiliary residual matrix M′″ no longer has any non-zero matrix elements. The matrix P, in which the total usability of the elements of the auxiliary matrix M″ are noted (top row in FIG. 4), has only entries with the value 1, since summations still occur in a row, but there are no more identical summations (in terms of amount) in other rows of the auxiliary matrix M″. Since the assessments P, s and q are the same for rows two and three of the auxiliary matrix M″, the lowest row number is used for the next summation (k1*v1+k2*v2)+k4*v3. Furthermore, it is taken into account that there are identical positions at the positions M″11 and M″21 in terms of amount.

The auxiliary residual matrix M′″ arises from the auxiliary matrix M″ by setting all matrix elements M″ij in the auxiliary matrix M″ to zero, which are involved in a summation b1 already scheduled in the sequence in FIG. 4, see row two in FIG. 4. The elements of the auxiliary residual matrix M′″ are also assessed with regard to their total usability (matrix P in row two of FIG. 4), this results in a further summation b2 in FIG. 4, the auxiliary residual matrix M′″ is then completely cleaned, see row three in FIG. 4. Finally, the summations b1, b2 in FIG. 4 are performed in the now extended scheduled sequence (in addition to the summations b1 and b2 from FIG. 3), and the sums resulting from the preceding extended summation are computed in each row of the result vector r by successive pairwise addition.

In the case of larger matrices, it may of course be necessary to repeat this process by repeating the previously described method step in the same way until the required number of summations for the matrix-vector multiplication has been completely broken down into a sequence of summations by two summands.

The result of the method 1 is that the following sequence of summations with product formations triggered by them is scheduled and implemented:

k1*v1,k2*v2 leads to k1*v1+k2*v2

k3*v2,k4*v3 leads to k3*v2+(−k4*v3)(k1*v1+k2*v2)+k4*v3(k3*v2−k4*v3)+(−k1*v1)

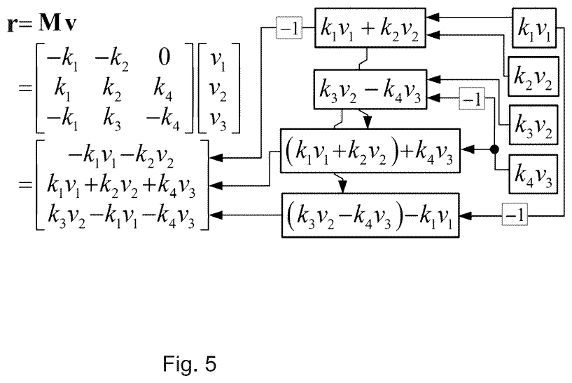

This result is shown in FIG. 5. The computation has been reduced to four multiplications and four additions. This means that the computations have been realized as quickly as possible on the basis of the available FPGA resources.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A computer-implemented method to test an ECU with a simulator, the method comprising:
computing numerically, via the simulator, a mathematical environment model on a computation unit;
simulating, via the environment model, an environment of the ECU at least in part;
coupling the ECU and the simulator to each other via corresponding I/O interfaces such that the ECU and simulator interact with each other;
during the numerical computation of the environment model, performing a matrix-vector multiplication on the simulator, in which a matrix is multiplied by a vector to form a result vector;
breaking down the matrix vector multiplication into a sequence of summations by two summands, each summand being a product of two factors, one factor being an element of the matrix and the other factor being an element of the vector;
determining, in a sequence determination step, the summation as the next summation in the sequence whose summands depend on matrix elements from a row of the matrix with the highest population;
selecting the matrix elements from a highest-populated row that have a highest total usability;
repeating the sequence determination step with a residual matrix instead of the matrix until the residual matrix no longer has any non-zero matrix elements;
deriving the residual matrix from the matrix by setting all matrix elements in the matrix to zero which are involved in a summation already scheduled in the sequence;
performing the summations in the scheduled sequence;
performing the product formations for calculating the summands in the sequence in which the summands are required to perform the summations; and
computing by successive pairwise addition, in a final summation step, the sums resulting from the preceding summation in each row of the result vector.

2. The method according to claim 1, wherein the matrix is examined for matrix elements of the same amount in a column of the matrix, since products of identical amount are to be computed at these matrix positions with the same matrix elements in a column, that a corresponding product of the amount of one of the matrix elements of the same amount and the amount of a corresponding vector element of the vector is computed only once and the computation result for the product at the other matrix positions with matrix elements identical in terms of amount is only retrieved and not recomputed or with a sign bit of the precomputed product in terms of amount being set accordingly if the matrix element and the corresponding vector element have different signs.

3. The method according to claim 1, wherein the matrix is examined for multiple identical matrix elements in two different rows and in identical columns of the matrix since this corresponds to identical sums or subtotals in the result vector, wherein such a sum or subtotal is computed only once, and wherein the computation result in the other rows with identical sums or subtotals for the computation of the result vector is only retrieved and not recomputed.

4. The method according to claim 1, wherein the total usability of an element of the matrix in the case of a non-zero element amount is valued at 1 if in the same row of the matrix another element of the matrix has a non-zero element amount and thus the element is involved in a summation in its row, and wherein the total usability each increases by the value 1 with each conceivable pair of summands in the row of the matrix, which is identical in terms of amount in another row in the matrix.

5. The method according to claim 1, wherein in the sequence determination step, in the presence of multiple rows in the matrix that are equally populated at the highest level, for each of these rows of the matrix, a summarized total usability is determined according to the sum of the total usability of the matrix elements of the corresponding row, and the row with the highest summarized total usability.

6. The method according to claim 5, wherein in the case there are multiple rows in the matrix equally populated at the highest level and with the same summarized total usability, one of these multiple rows is selected by chance, or by choosing the row with the smallest row number, or by choosing the row with the largest row number.

7. The method according to claim 1, wherein in the final summation step an auxiliary matrix is formed with a number of rows corresponding to the number of rows in the matrix and with a number of columns corresponding to the number of summations in the already specified sequence of summations, wherein, in each column, a summation of the already determined sequence of summations is entered in the row to which the summation contributes in the result vector, wherein the sequence determination step is performed with the auxiliary matrix, wherein the sequence determination step is repeated with an auxiliary residual matrix instead of the auxiliary matrix until the auxiliary residual matrix no longer has any non-zero matrix elements, wherein the auxiliary residual matrix is derived from the auxiliary matrix by setting all matrix elements in the auxiliary matrix to zero that are involved in a summation already scheduled in the sequence, wherein the summations are performed in the now extended scheduled sequence, and wherein the sums resulting in the preceding extended summation are computed in each row of the result vector by consecutive pairwise addition.

8. The method according to claim 7, wherein the method step is repeated analogously until the required number of summations for the matrix-vector multiplication has been completely broken down into a sequence of summations by two summands.

9. The method according to claim 1, wherein the ECU is a real ECU or a virtual ECU.

10. The method according to claim 1, wherein the determined sequence for the summations is used as a basis for calculating the matrix-vector multiplication in the context of the environment model and the environment model is transferred into a hardware description for a programmable logic module, and wherein the programmable logic module is the computational unit of the simulator and is configured with the hardware description.

11. A computer program containing commands which, when executed with a simulator, causes the simulator to execute the method according to claim 1.
